(19) United States
(12) Patent Application Publication
(10) Pub. No.: US 2007/0275709 A1
(43) Pub. Date: Nov. 29, 2007

(54) UNAUTHORIZED DEVICE-USE PREVENTION SYSTEM AND DEVICE

(75) Inventor: Huang Lei, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 11/752,396

(22) Filed: May 23, 2007

(30) Foreign Application Priority Data
May 24, 2006 (JP) 2006-144472

(51) Int. Cl. H04M 3/00; G05B 9/02; H04Q 7/20

(52) U.S. Cl. 455/421; 700/79; 455/419

(57) ABSTRACT

Disclosed is a system including a device which has a short-range wireless communication section in a device body and an attachment unit, removably mounted on or connected to the device body, for performing weak, short-range wireless communication between the device and the attachment unit. When it is detected that the device body and the attachment unit are disconnected, the weak communication is started between the body-side short-range wireless communication section and the unit-side short-range wireless communication section. If a body-side attachment unit authentication section does not detect a legitimate attachment unit within a weak communication range or if it is detected that the attachment unit is mounted on or connected to the device body, a controller of the device body notifies an error and the lock function of the controller inhibits the use of the device.

### FIELD OF THE INVENTION

The present invention relates to an unauthorized device-use prevention system and device that prevent an unauthorized third party from using a device such as a computer or a mobile phone.

### BACKGROUND OF THE INVENTION

An example of a system for preventing unauthorized use of a device is disclosed, for example, in Patent Document 1. The system for preventing unauthorized use of a portable information terminal described in Patent Document 1, in which a wrist watch and a portable information terminal can regularly communicate with each other over short-range wireless communication, comprises authentication means that requests user authentication when the portable information terminal cannot perform regular communicate with the write watch. If correct user authentication information is not entered, the portable information terminal turns off the power to prevent an unauthorized user from using the terminal.

Patent Document 2 discloses a portable communication terminal that performs a weak, short-range wireless communication between a portable communication terminal body and an attachment unit, removably mounted on or connected to the terminal body, to prevent an unauthorized user from using the portable communication terminal. The portable communication terminal described in Patent Document 2 has weak-communication means, one for each of the portable communication terminal body and the attachment unit. This portable communication terminal starts weak communication upon detecting that the attachment unit is detached from the terminal body. When the portable communication terminal detects that the attachment unit gets out of the weak communication range, the lock function of the control section of the portable communication terminal body is activated to limit the use of the terminal.

### [Patent Document 1]

Japanese Patent Kokai Publication No. JP-P2002-300651A (paragraphs 0013-0016, FIG. 1)

### [Patent Document 2]

Japanese Patent Kokai Publication No. JP-P2005-151392A (paragraphs 0029-0034, FIG. 1)

### SUMMARY OF THE DISCLOSURE

However, according to the system for preventing the unauthorized use of a portable information terminal disclosed in Patent Document 1, the user must have a special wrist watch and always carry both the wrist watch and the portable communication terminal. This system is inconvenient because the user sometimes fails to do so. In contrast, according to the portable communication terminal disclosed in Patent Document 2, the attachment unit, capable of weak communication, is removably mounted on or connected to the portable communication terminal body and, therefore, it is less likely that the user fails to carry the attachment unit. However, the drawback with the portable communication terminal disclosed in Patent Document 2 is that there is a possibility that the portable communication terminal body and the attachment unit are lost at the same time, in which case it is difficult to completely prevent the unauthorized use by a third party, that is, by a person who is not the owner.

Accordingly, an exemplary object of the present invention is to provide an unauthorized device-use prevention system and device that can easily prevent the unauthorized use without providing special means and without affecting daily operations even if a lost, left-behind, or stolen device, such as a portable communication terminal, will be used by an unauthorized user.

The above and other objects are attained by an unauthorized device-use prevention system in accordance with one aspect of the present invention, for preventing an unauthorized use of a device by a third party, comprising a device body; and an attachment unit that is removably mounted on or connected to said device body, wherein said attachment unit comprises a unit-side short-range wireless communication section that performs short-range wireless communication, which is a wireless communication over a preset short distance, with said device body; and wherein said device body comprises: a body-side short-range wireless communication section that performs short-range wireless communication with said attachment unit;

a unit authentication section that detects an attachment unit existing in a predetermined distance range via the short-range wireless communication to determine whether or not the detected attachment unit is a legitimate attachment unit; and

a lock control section that sets said device body in a lock state, in which a use of said device body is regulated, if said unit authentication section does not detect the legitimate attachment unit within a predetermined distance range.

The device body may further comprise unit sensing means that senses if the attachment unit is mounted or connected wherein the lock control section sets the device body in the lock state if the unit sensing means senses that the attachment unit is mounted or connected.

The lock control section may set the device body in the lock state if the attachment unit, disconnected from the device body, is in the predetermined distance range but is not detected to be a legitimate attachment unit.

The device body may further comprise a user authentication section that performs user authentication based on information entered by a user operation or user biometric information that is detected, and the lock control section may release the lock state if a current user is authenticated to be a legitimate user by the user authentication section.

The user authentication section may use one of a fingerprint, iris, and vein or a combination information thereof as the biometric information.

The device body may further comprise a disconnection detection section that controls the body-side short-range wireless communication means to start the short-range wireless communication with the attachment unit if the attachment unit is detected to be disconnected.

A device in accordance with another aspect of the present invention, which is a device for use in an unauthorized device-use prevention system that prevents an unauthorized use of the device by a third party, comprises: a body-side short-range wireless communication section that performs short-range wireless communication, which is a wireless communication over a preset short distance, with an attachment unit that is removably mounted on or connected to said device;

a unit authentication section that detects an attachment unit existing in a predetermined distance range via said short-range wireless communication to determine whether or not the detected attachment unit is a legitimate attachment unit; and

a lock control section that sets said device in a lock state, in which a use of the device is regulated, if the legitimate attachment unit is not detected within the predetermined distance range by said unit authentication section.

The device may further comprises an error notification section that notifies the lock control section about an error if the unit authentication section does not detect the legitimate attachment unit within the predetermined distance range wherein, in response to an error notification from the error notification means, the lock control section sets the device in the lock state.

The meritorious effects of the present invention are summarized as follows.

According to the present invention, the short-range wireless communication between the device body and the attachment unit removably mounted on or connected to the device body, which is performed by the short-range wireless communication section, allows the unit authentication section to check if there is a legitimate attachment unit within the predetermined distance range. This enables the device to activate the lock function according to whether or not the legitimate attachment unit is connected, thereby preventing an unauthorized third party from using the device.

According to the present invention, the lock function can be activated if the unit sensing section, which senses whether or not the attachment unit is mounted, senses that the attachment unit is mounted. Therefore, it is less likely that, even if both the attachment unit and the device body are stolen, an unauthorized third party uses the device unless the lock state is released by successful user authentication. This means that, even if there is a possibility that a lost, left-behind, or stolen device such as a portable communication terminal will be used by an unauthorized third party, the system of the present invention allows the user to easily prevent its unauthorized use without using special means and without affecting the daily use.

Still other features and advantages of the present invention will become readily apparent to those skilled in this art from the following detailed description in conjunction with the accompanying drawings wherein examples of the invention are shown and described, simply by way of illustration of the mode contemplated of carrying out this invention. As will be realized, the invention is capable of other and different examples, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a block diagram showing an example of the configuration of an unauthorized device-use prevention system applied to a mobile phone.

FIG. 2 is a flowchart showing an example of operation in an example.

FIG. 3 is a flowchart showing an example of operation in the example.

### EXAMPLES OF THE INVENTION

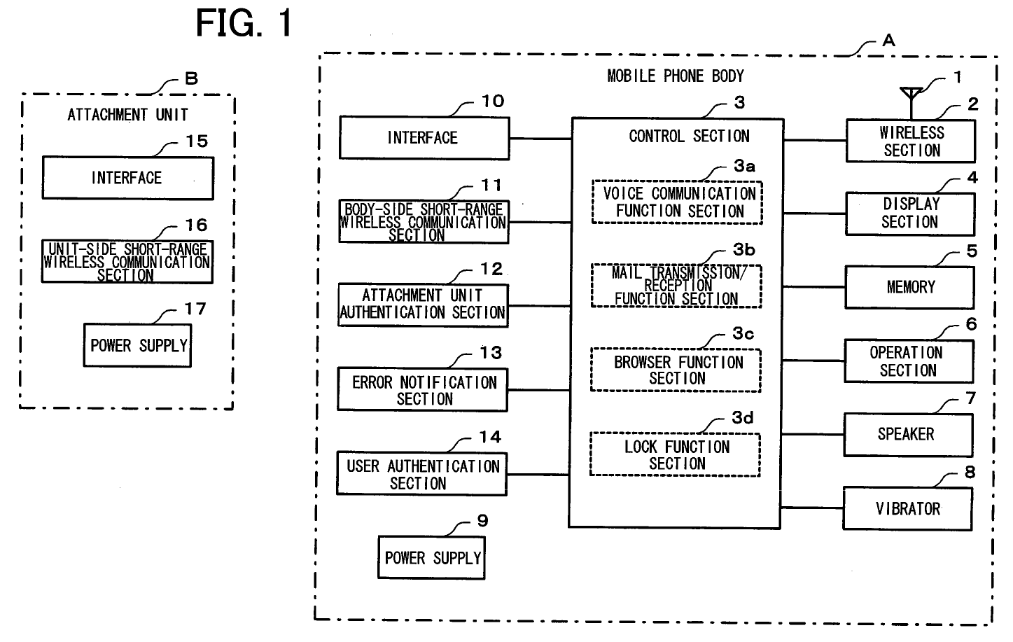

Examples of the present invention will be described with reference to the drawings. FIG. 1 is a block diagram showing an example of the configuration of an unauthorized device-use prevention system in an example applied to a mobile phone. The unauthorized device-use prevention system shown in FIG. 1 comprises a mobile phone body (hereinafter simply termed a “body”) A and an attachment unit B that is removably mounted on or connected to the mobile phone.

As with a standard mobile phone, the body A comprises an antenna 1 and a wireless section 2 for communicating with a base station wirelessly, a control section 3 such as a CPU that performs an operation according to a program, a display section 4 such as a liquid crystal display, a memory 5, an operation section 6 such as a keyboard, a speaker 7, a vibrator 8, and a power supply 9. The control section 3 includes a voice communication function section 3a that controls the implementation of various functions of the mobile phone, a mail transmission/reception function section 3b, and a browser function section 3c for browsing the Internet.

In addition to the components described above, the body A further comprises the following components for carrying out the present invention: an interface section 10 that operates as an interface with the attachment unit B, a body-side short-range wireless communication section 11 that performs short-range (for example, 100 m or shorter) wireless communication (hereinafter termed a weak communication) with the attachment unit B using a weak radio wave, an attachment unit authentication section 12 that authenticates the attachment unit via the weak communication, an error notification section 13 that notifies the control section 3 about the authentication error of the attachment unit, and a user authentication section 14 that authenticates the user via an entered password or biometric information such as fingerprints when the attachment unit B is mounted on or connected to the body A but weak communication is not performed or when an attachment unit authentication error is detected. In addition, the control section 3 includes a lock function section 3d that limits the use of the terminal. The interface section 10 also works as attachment detection means that detects whether or not the attachment unit B is mounted on or connected to the body A.

The interface section 10 is implemented, for example, by a socket corresponding to the attachment unit. The attachment unit authentication section 12 and the error notification section 13 are implemented, for example, by the CPU that performs an operation based on a program. The user authentication section 14 is implemented, for example, by a sensor device that senses information used for user authentication (password and biometric information) and the CPU that performs an operation based on a program.

The attachment unit B comprises an interface 15 that acts as an interface with the body A, a unit-side short-range wireless communication section 16 that performs short-range wireless communication (weak communication) with the body A using a weak radio wave, and a power supply 17 for supplying a small power. As with the interface section 10 on the body side, the interface 15 has attachment detection means that detects whether the attachment unit B is mounted on, or connected to, the body A.

In the present invention, it is assumed that the attachment unit B can be removably mounted on the body A or removably connected to the casing of the body A using connection means such as a connector or a cord. The attachment unit B may be a dedicated unit for implementing the present invention or a mobile phone strap or a memory card which can be removably mounted on or connected to the body A and has an additional function to implement the present invention.

Although FIG. 1 shows a mobile phone as an example of the device body, the present invention may also be applicable to an information processing device such as a personal computer, a copier, or an electronic diary.

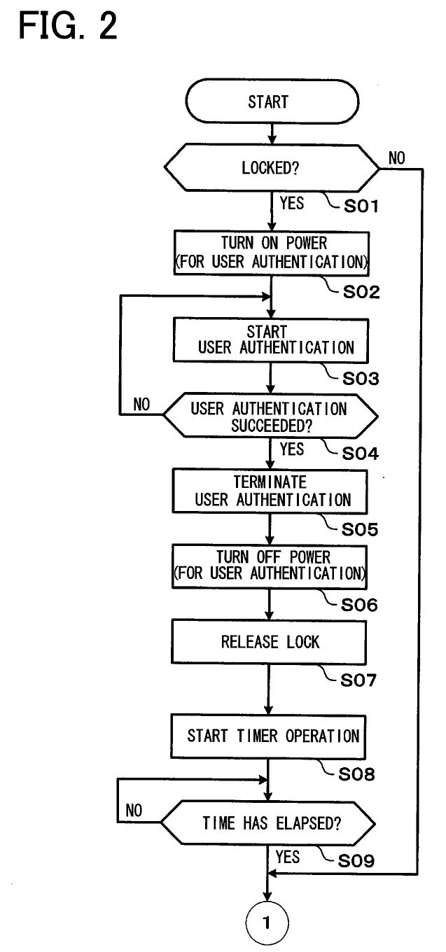

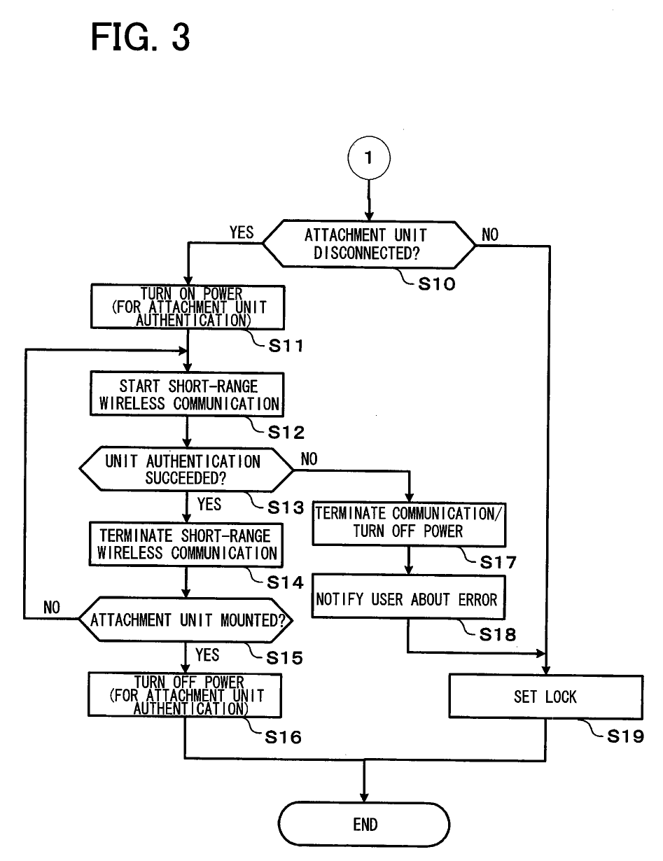

Next, the following describes the operation of this example. FIG. 2 and FIG. 3 are flowcharts showing an example of the operation of this example.

First, if the body A is locked (lock mode) (step S01), the control section 3 of the body A starts supplying the power to the user authentication section 14 (step S02). The user authentication section 14 receives the power and starts user authentication (step S03). In step S03, the user authentication section 14 displays message information on the display section 4 to prompt the user to enter an authentication password for user authentication and accepts the authentication password entered from the operation section 6. Alternatively, it is also possible for the user authentication section 14 to include detection means (sensor, etc.), which detects biometric information such as a user's fingerprint, iris, or voiceprint, for detecting the biometric information on the current user using the detection means. The biometric information may be information on the finger print, iris, voiceprint, or vein or any combination of them. The use of biometric information ensures more reliable authentication. It is also possible to automatically detect authentication information without giving the user any trouble.

When the authentication password is entered (or biometric information is detected), the user authentication section 14 checks if the entered authentication password (or detected biometric information) matches the authentication password (or biometric information) stored in the body A in advance (step S04). In the description below, the information used for authentication and detected from the current user, such as entered authentication password or detected biometric information, is termed detected authentication information. In contract, the authentication information stored in the body A in advance is termed stored authentication information. If the detected authentication information matches the stored authentication information, that is, if the authentication succeeds (Yes in step S04), the user authentication section 14 terminates the user authentication (step S05). When the user authentication is terminated, the control section 3 releases the lock state (step S07). The control section 3 clears the flag indicating the lock state and returns the body A to the normal-operation state. At this time, the control section 3 may also control the power supply 9 to stop the supply of power for user authentication (step S06). Next, the control section 3 starts the timer operation (step S08), waits until a pre-defined timer setting time elapses (Yes in step S09), and performs the lock control operation according to whether or not the attachment unit B is connected.

If the detected authentication information does not match the stored authentication information in step S04, that is, if the user authentication fails (No in step S04), the user authentication is repeated until the user authentication succeeds (return to step S03).

If the lock state is released after the user authentication is terminated successfully and a predetermined time elapses (after step S09) or if the body A is not locked (No in step S01), the control section 3 performs the lock control operation according to whether the attachment unit B is connected. First, the control section 3 checks if the attachment unit B is disconnected from the body A (step S10). For example, the control section 3 references the attachment state of the attachment unit B, detected by the attachment detection means of the interface 10, to check if the attachment unit B is connected. The interface section 10, for example, monitors the level of the signal, which is output from the connecting unit connected to the attachment unit, and checks for a change in the signal level (for example, detects if the signal level is changed from High to Low) to detect the attachment state.

If the body A and the attachment unit B are disconnected, both the body A side and the unit side start supplying the power for authenticating the attachment unit (step S11). In step S11, the control section 3 of the body A controls the power supply 9 to start supplying the power to the body-side short-range wireless communication section 11, attachment unit authentication section 12, and error notification section 13. Also, on the attachment unit B, when the interface 15 detects that the attachment unit B is disconnected from the body A, the attachment unit B may start supplying the power to the unit-side short-range wireless communication section 16 in the same way as the body A. When the power is supplied to both the body-side short-range wireless communication section 11 of the body A and the unit-side short-range wireless communication section 16 of the attachment unit B, the body-side short-range wireless communication section 11 and the unit-side short-range wireless communication section 16 start the weak communication between the body A and the attachment unit B (step S12).

The weak communication refers to a wireless communication by a radio wave in a specific frequency band that conforms to the short-distance specification (for example, Bluetooth (registered trademark)) and that does not interfere the usual communication performed by the wireless section 2 or refers to an infrared communication that conforms to the short-distance specification. When the weak communication is performed by Bluetooth, both the body-side short-range wireless communication section 11 and the unit-side short-range wireless communication section 16 are implemented by a Bluetooth module.

When the body-side short-range wireless communication section 11 and the unit-side short-range wireless communication section 16 start the weak communication, the attachment unit authentication section 12 authenticates the unit by checking if the attachment unit B is within a predetermined distance range and if the attachment unit B is a legitimate attachment unit (step S13). For example, the attachment unit authentication section 12 measures the electric field strength of the carrier used in the weak communication with the attachment unit B and checks whether or not the electric field strength falls below a predetermined threshold to determine if the attachment unit B is within the predetermined distance range. It is also possible for the attachment unit authentication section 12 to store identification information identifying the attachment unit B both in the body A and in the attachment unit B and compares the identification information, which is added to the information received from the attachment unit B via the weak communication, with the identification information stored in the body A to determine if the attachment unit B is a legitimate attachment unit. In this case, it is assumed that the attachment unit B adds the identification information, stored in the attachment unit B, to the information that is sent during the weak communication.

If the unit authentication succeeded, that is, if the legitimate attachment unit is detected within a predetermined distance range (Yes in step S13), the attachment unit authentication section 12 once terminates the weak communication (step S14). Next, until the interface section 10 detects that the attachment unit B is mounted on or connected to the body A, the unit verification is performed repeatedly through the weak communication (No in step S15 and return to step S12). The attachment unit authentication section 12 resumes the weak communication after a fixed period elapses. Therefore, when the body A and the legitimate attachment unit B are within the predetermined distance range with the attachment unit B disconnected, the weak communication is repeated periodically.

If the interface section 10 detects that the attachment unit B is mounted on or connected to the body A (Yes in step S15), the supply of the power for unit authentication is stopped (step S16). For example, the control section 3 of the body side controls the power supply 9 to stop the supply of power to the body-side short-range wireless communication section 11, attachment unit authentication section 12, and error notification section 13. The attachment unit B side also performs the same operation as the body A. That is, if the interface 15 detects that the attachment unit B is mounted on or connected to the body A, the supply of power from the power supply 17 to the unit-side short-range wireless communication section 16 may be stopped.

If the unit authentication fails in step S13, that is, if the legitimate attachment unit is not detected within the predetermined distance range, the error notification section 13 notifies the control section 3 about the error, the weak communication is terminated, and the supply of power for unit authentication is stopped (step S17). The control section 3, which receives the notification from the error notification section 13, controls one of the display section 4, speaker 7, and vibrator 8 to issue an error generation warning to the user (step S18). Next, the control section 3 activates the lock function section 3d to move the body A to the lock state (lock mode) to inhibit the use of the body A (step S19). For example, the control section 3 sets the flag indicating the lock state and puts the body A in the lock mode. The body A, once put in the lock mode, inhibits data entry from the operation section 6, data readout from the memory, signal generation from the wireless section 2, and signal reception by the wireless section 2 to prevent an unauthorized third party from using the body A.

If it is detected in step S10 that the body A and the attachment unit B are not disconnected, the control section 3 puts the body A in the lock mode (No in step S10, and go to step S19).

After that, the sequence of steps is terminated. Control returns to step S01 again and, if the body A is locked, the user is authenticated, the lock is released, and then the lock control operation is performed according to whether the attachment unit is connected.

Therefore, even if the body A is lost with the attachment unit B disconnected, the body A detects an error through the unit authentication via the weak communication and moves to the lock state. After that, unless the user authentication succeeds, the body A does not return to the normal-operation state, meaning that the system more reliably prevents an unauthorized use. Even if the user authentication succeeds, the body A moves to the lock state again unless the unit verification through the weak communication with the legitimate attachment unit succeeds by the time a predetermined time elapses, meaning that the system prevents an unauthorized use more reliably. If the body A is lost with the attachment unit B not disconnected (that is, both the body A and the attachment unit B are lost), the body A moves to the lock state periodically. In this case, unless the user authentication succeeds each time the body A moves to the lock state, the function of the body A is limited and, therefore, it is unlikely that the body A will be used by an unauthorized third party. As described above, biometric information can be used for user authentication by automatically detecting the biometric information. By doing so, a legitimate user can release the lock state without spending much time in user authentication and, therefore, perform the operation continuously.

Even if there is a possibility that a lost, left-behind, or stolen portable communication terminal will be used by an unauthorized third party, the system in the example described above allows the user to easily prevent its unauthorized use without using special means for giving an instruction remotely and without affecting the daily use of the portable communication terminal.

Although an error notification is sent to the user in step S18 in the example described above, it is also possible to send the notification, not to the current user, but to a legitimate user. For example, the system may control the mail transmission/reception function section 3b to send an error-notification electronic mail to the pre-registered mail address.

The attachment unit is not required to be removably mounted on the body; instead, the body is required only to detect whether the attachment unit is disconnected from a predetermined device. For example, the attachment unit may be removably mounted on another device connected to the body casing. For example, it is possible that a wireless room-admission tag required to enter a room, where there are provided computers for processing confidential information, is the attachment unit and that an entry/exit control device installed in the room and connected wirelessly or via a wire to a storage device in which the attachment unit is stored is the body. In that case, an employee does not carry home his or her wireless room-admission tag but stores it in a storage box. When an employee comes to the office, the employee takes his or her own wireless room-admission tag from the storage box, attaches the tag to himself or herself, and receives biometric authentication by the entry/exit control device installed on the door. Then, the wireless room-admission tag becomes usable and the employee can open the door. After that, the wireless room-admission tag remains effective while the employee stays within a determined range and, therefore, the employee can enter or leave the room freely. When the employee leaves the office, the employee returns the wireless room-admission tag to the storage box. Then, the wireless room-admission tag becomes ineffective and the employee cannot enter the room. That is, using the system in this way reduces the possibility of losing the attachment unit and easily prevents an unauthorized use.

The present invention is applicable not only to mobile phones but to portable terminals such as personal digital assistants. The present invention is also applicable not only to portable type devices but also to information processing devices such as personal computers and copiers that process confidential information. In addition, the present invention is applicable to devices that limit the use of a building or the admission to a room.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An unauthorized device-use prevention system that prevents an unauthorized use of a device by a third party, said system comprising:
a device body; and
an attachment unit that is removably mounted on or connected to said device body; wherein
said attachment unit comprises a unit-side short-range wireless communication section that performs short-range wireless communication, which is a wireless communication over a preset short distance, with said device body; and wherein
said device body comprises:
a body-side short-range wireless communication section that performs short-range wireless communication with said attachment unit;
a unit authentication section that detects an attachment unit existing in a predetermined distance range via the short-range wireless communication to determine whether or not the detected attachment unit is a legitimate attachment unit; and
a lock control section that sets said device body in a lock state, in which a use of said device body is regulated, if said unit authentication section does not detect the legitimate attachment unit within a predetermined distance range.

2. The system according to claim 1, wherein said device body further comprises a unit sensing section that senses if said attachment unit is mounted thereon or connected thereto; wherein said lock control section sets said device body in the lock state, when said unit sensing section senses that said attachment unit is mounted on or connected to said device body.

3. The system according to claim 1, wherein said lock control section sets said device body in the lock state, if said attachment unit, disconnected from said device body, is in the predetermined distance range but is not detected to be a legitimate attachment unit.

4. The system according to claim 1, wherein said device body further comprises a user authentication section that performs user authentication based on information entered by a user operation or user biometric information that is detected; and
wherein said lock control section releases the lock state when a current user is authenticated to be a legitimate user by said user authentication means.

5. The system according to claim 4, wherein said user authentication section uses one of a fingerprint, iris, voiceprint, and vein or a combination information thereof as the biometric information.

6. The system according to claim 1, wherein said device body further comprises a disconnection detection section that detects the disconnection of said attachment unit from said device body and that controls said body-side short-range wireless communication section to start the short-range wireless communication with said attachment unit, when said attachment unit is detected to be disconnected.

7. A device for use in an unauthorized device-use prevention system that prevents an unauthorized use of the device by a third party, said device comprising:
a body-side short-range wireless communication section that performs short-range wireless communication, which is a wireless communication over a preset short distance, with an attachment unit that is removably mounted on or connected to said device;
a unit authentication section that detects an attachment unit existing in a predetermined distance range via said short-range wireless communication to determine whether or not the detected attachment unit is a legitimate attachment unit; and
a lock control section that sets said device in a lock state, in which a use of the device is regulated, if the legitimate attachment unit is not detected within the predetermined distance range by said unit authentication section.

8. The device according to claim 7, further comprising an error notification section that notifies said lock control section about an error if said unit authentication section does not detect the legitimate attachment unit within the predetermined distance range,
wherein, in response to an error notification from said error notification section, said lock control section sets said device in the lock state.
